(19) United States
(12) Patent Application Publication
(10) Pub. No.: US 2007/0161405 A1
(43) Pub. Date: Jul. 12, 2007

(54) CALL VOLUME ADJUSTMENT METHOD AND MOBILE COMMUNICATION TERMINAL USING THE SAME

(75) Inventor: Guk Chan Lim, Gyeonggi-do (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG ELECTRONICS INC.

(21) Appl. No.: 11/620,534

(22) Filed: Jan. 5, 2007

(30) Foreign Application Priority Data
Jan. 6, 2006 (KR) 10-2006-0001795

(51) Int. Cl. H04B 1/38

(52) U.S. Cl. 455/557; 455/569.2; 455/418

(57) ABSTRACT

A call volume adjustment method and a mobile communication terminal using the same are disclosed. The method includes sensing if a pressure part of the mobile communication terminal is pressurized, determining the level of pressure applied to the pressure part upon sensing that the pressure part is pressurized, and adjusting the call volume of the mobile communication terminal according to the determined pressure level. Therefore, it is possible to adjust the call volume simply and conveniently without operating a specific key.

### CROSS REFERENCE TO RELATED APPLICATION

This application claims the priority benefit of Korean Patent Application No. 10-2006-0001795, filed on Jan. 6, 2006, which is hereby incorporated by reference as if fully set forth herein.

### BACKGROUND OF THE INVENTION

1. Field of the Invention

The present invention is related to a call volume adjustment method and a mobile communication terminal, and more specifically, to a method which is capable of adjusting a call volume without operating keys during a call, and a mobile communication terminal using the same.

2. Discussion of the Related Art

Conventionally, in order to adjust a call volume of a mobile communication terminal (terminal) during a call, a user of the terminal uses a side key provided at a side surface of the terminal. The side key includes an up key for increasing the call volume, and a down key for decreasing the call volume.

A conventional process of adjusting the call volume of the terminal will hereinafter be described with reference to FIG. 1.

In a call state (S102), the terminal determines whether the side key has been pushed to adjust the call volume (S104). Upon determining that the side key has been pushed, the terminal determines if the up key or the down key has been pushed (S106). If it is determined that the up key has been pushed, the terminal increases the current call volume by one level (S108).

On the other hand, if it is determined that the down key has been pushed, the terminal decreases the current call volume by one level (S110).

However, the conventional process is disadvantageous in that the user has the inconvenience of having to operate a specific key to adjust the call volume during the call.

### SUMMARY OF THE INVENTION

An object of the present invention is to provide a method which is capable of adjusting a call volume simply and conveniently without operating a specific key during a call, and a mobile communication terminal using the same.

In one aspect of the present invention, a method for adjusting a call volume of a mobile communication terminal, comprises: sensing whether a pressure part of the mobile communication terminal is pressurized; determining a level of pressure applied to the pressure part upon sensing that the pressure part is pressurized; and adjusting the call volume of the mobile communication terminal according to the determined pressure level.

In another aspect of the present invention, a method for adjusting a call volume of a mobile communication terminal comprises: sensing whether a pressure part of the mobile communication terminal is pressurized; determining a level of pressure applied to the pressure part upon sensing that the pressure part is pressurized; and adjusting the call volume of the mobile communication terminal according to the determined pressure level, wherein the level of pressure can be determined by the pressure of a user's ear on the pressure part.

In another aspect of the present invention, a mobile communication terminal with a call volume adjustment function comprises: a pressurization sensing unit adapted to sense whether a pressure part of the mobile communication terminal is pressurized and to determine a level of pressure applied to the pressure part; a controller adapted to adjust a call volume of the mobile communication terminal according to the pressurization sensing unit result; and a speaker adapted to output an audio signal with the adjusted call volume. In alternative aspect of the present invention, the pressure part is provided at a portion of the speaker, and the level of pressure can be determined according to the pressure of a user's ear on the pressure part.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a flowchart illustrating a conventional call volume adjustment process;

FIG. 2 is a block diagram illustrating the internal configuration of a mobile communication terminal with a call volume adjustment function according to the present invention;

FIG. 3 is a flowchart illustrating a method for adjusting the call volume of the mobile communication terminal according to the present invention;

FIG. 4A is a side view of a first embodiment of the mobile communication terminal according to the present invention under the condition that a stopper of the terminal is not pressurized;

FIG. 4B is a side view of the first embodiment of the mobile communication terminal according to the present invention under the condition that the stopper of the terminal is pressurized;

FIG. 5A is a front view of a second embodiment of the mobile communication terminal according to the present invention, which is a bar type and has a pressure part to be pressurized;

FIG. 5B is a front perspective view of a third embodiment of the mobile communication terminal according to the present invention, which is a slide type and has a pressure part to be pressurized;

FIG. 5C is a front view of a fourth embodiment of the mobile communication terminal according to the present invention, which is a folder type and has a pressure part to be pressurized;

FIG. 6A illustrates the internal configuration of a first embodiment of a pressurization sensing unit of the mobile communication terminal according to the present invention under the condition that a pressure part of the terminal is not pressurized;

FIG. 6B illustrates the internal configuration of the first embodiment of the pressurization sensing unit of the mobile communication terminal according to the present invention under the condition that the pressure part of the terminal is pressurized;

FIG. 7A illustrates the internal configuration of a second embodiment of the pressurization sensing unit of the mobile communication terminal according to the present invention under the condition that the pressure part of the terminal is not pressurized; and

FIG. 7B illustrates the internal configuration of the second embodiment of the pressurization sensing unit of the mobile communication terminal according to the present invention under the condition that the pressure part of the terminal is pressurized.

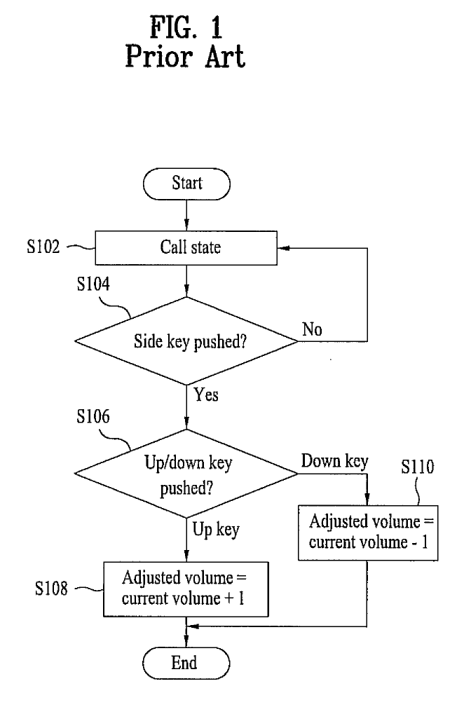

### DETAILED DESCRIPTION OF THE INVENTION

Reference will be made in detail to the preferred embodiments of the present invention, examples of which are illustrated in the accompanying drawings. Wherever possible, the same reference numbers will be used throughout the drawings to refer to the same or like parts. In the following description of the present invention, a detailed description of known functions and configurations incorporated herein will be omitted when it may make the subject matter of the invention rather unclear.

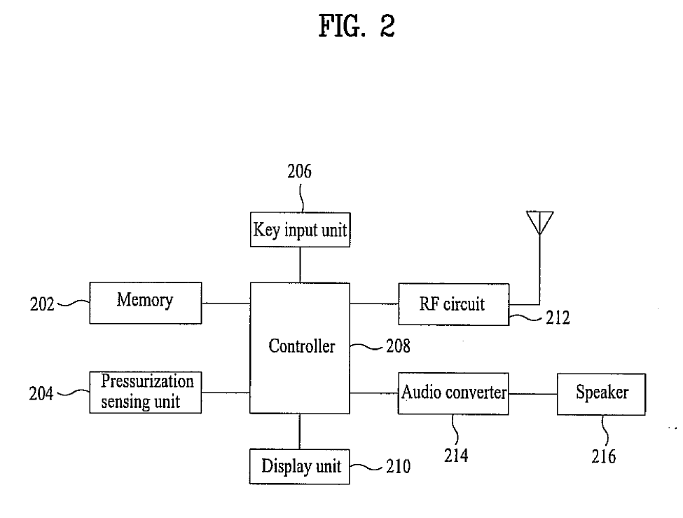

The internal configuration of a mobile communication terminal with a call volume adjustment function according to the present invention will hereinafter be described in detail with reference to FIG. 2.

As illustrated in FIG. 2, the mobile communication terminal (terminal) comprises a memory 202, a pressurization sensing unit 204, a key input unit 206, a controller 208, a display unit 210, a radio frequency (RF) circuit 212, an audio converter 214, and a speaker 216.

The memory 202 stores programs for controlling of the entire operation of the terminal. The memory 202 also stores, in a predetermined area thereof, data which is inputted and outputted when the entire operation of the terminal is controlled by the controller 208.

The pressurization sensing unit 204 senses whether a pressure part of the terminal is pressurized and determines the level of pressure (pressure level) applied to the pressure part upon sensing that the pressure part is pressurized.

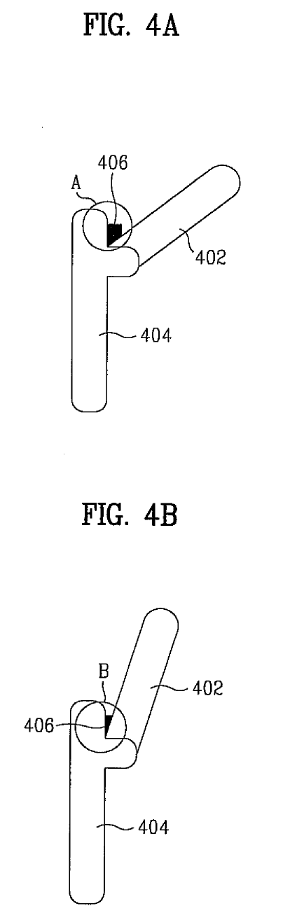

With reference to FIG. 4A and FIG. 4B, a description will hereinafter be given of a first embodiment of the terminal according to the present invention, which is a folder type and wherein the pressure part is a stopper provided between an upper folder and a lower folder.

FIG. 4A is a side view of the first embodiment of the terminal, wherein the stopper is not pressurized under the condition that the upper folder is open, and FIG. 4B is a side view of the first embodiment of the terminal, wherein the stopper is pressurized under the condition that the upper folder is open.

As illustrated in FIG. 4A, the terminal according to the first embodiment comprises the upper folder 402, the lower folder 404, and the stopper 406. The upper folder 402 includes the speaker 216 and the display unit 210 (both not shown), and the lower folder 404 includes the keypad or key input unit 206 (not shown). The stopper 406 is a device for reducing mechanical interference of the upper folder 402 with the lower folder 404 when the upper folder 402 is open, and it should be noted, that the device is not limited to the term “stopper” as long as it performs the same function.

Because the stopper 406 is provided between the upper folder 402 and the lower folder 404, it may be pressurized as the upper folder 402 is open. In addition, the stopper 406 may be pressurized as the user's ear is pressed against the upper folder 402. It should be noted here that the pressurization sensing unit 204 has a predetermined reference pressure level and thus senses that the stopper 406 is pressurized only when the level of pressure applied to the stopper 406 is equal to or greater than the reference pressure level. In this embodiment, FIG. 4A shows when the pressurization sensing unit 204 senses that the stopper 406 is not pressurized because the level of pressure applied to the stopper 406 is less than the reference pressure level.

On the other hand, as shown in FIG. 4B, pressure equal to or greater than the reference pressure level may be applied to the stopper 406 as the user's ear is pressed against the upper folder 402. In this embodiment, FIG. 4B shows when the pressurization sensing unit 204 senses that the stopper 406 is pressurized because the level of pressure applied to the stopper 406 is equal to or greater than the reference pressure level.

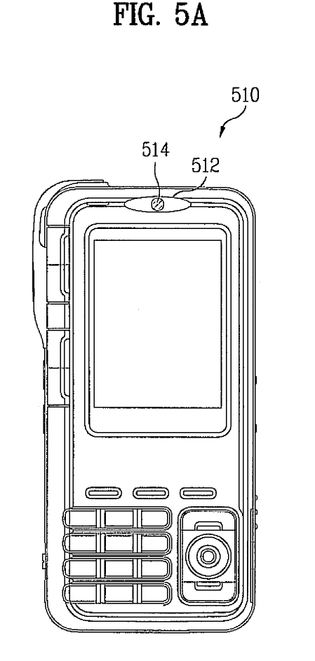

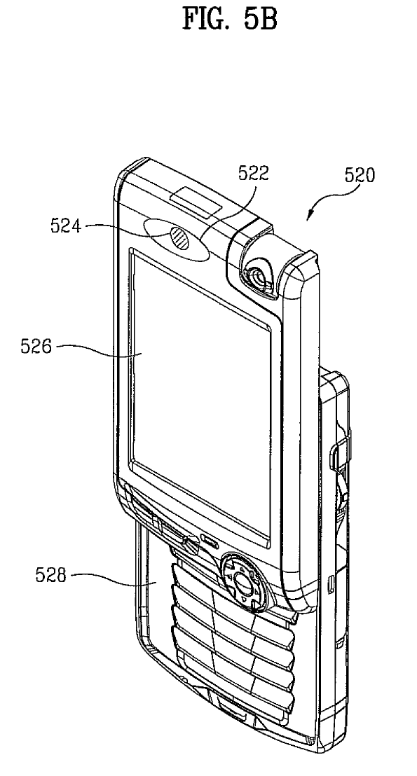

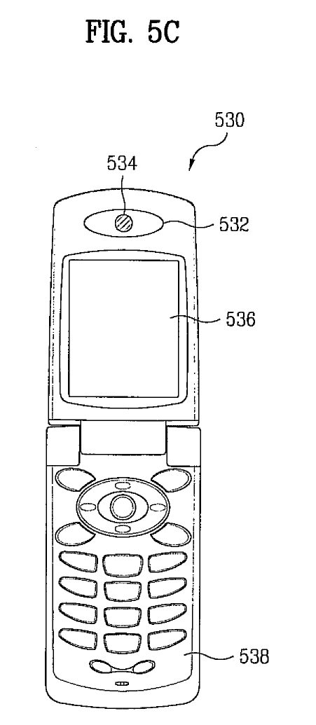

With reference to FIGS. 5A, 5B and 5C, a description will hereinafter be given of various embodiments of the terminal according to the present invention which have various parts to be pressurized.

FIG. 5A illustrates a second embodiment of the present invention, a bar-type terminal 510 wherein a pressure part 514 is provided at a portion of a speaker 512. The pressure part 514 is adapted to be sensitively pressurized when pressed by the user's ear, The pressure part 514 is connected to the pressurization sensing unit 204.

FIG. 5B shows a third embodiment of the present invention, a slide type terminal 520 consisting of an upper casing 526 and a lower casing 528 and wherein a pressure part 524 to be pressurized is provided at a portion of a speaker 522. The speaker 522 is generally installed in the upper casing 526, and the pressure part 524 is connected to the pressurization sensing unit 204.

FIG. 5C illustrates a fourth embodiment of the present invention, a folder-type terminal 530 consisting of an upper folder 536 and a lower folder 538, wherein a pressure part 534 to be pressurized is provided at a portion of a speaker 532. The speaker 532 is generally installed in the upper folder 536, and the pressure part 534 is connected to the pressurization sensing unit 204.

As illustrated in FIGS. 5A, 5B and 5C, the pressure part is provided at a portion of the speaker of the terminal. That is, the pressure part can be sensitively pressurized as the user presses his ear against the terminal to listen more carefully to an audio signal outputted from the terminal. In this regard, it is to be understood that the pressure part may be any part of the terminal that can be sensitively pressurized according to the degree of being pressed by the user's ear.

The pressurization sensing process and the applied pressure level determination process, performed by the pressurization sensing unit 204, will be described later in detail.

Referring again to FIG. 2, the key input unit 206 has a plurality of key buttons for inputting various characters including numerals, letters, symbols, etc. When one of the desired key buttons is pushed by the user, the key input unit 206 generates key data corresponding to the pushed key button, and then outputs the generated key data to the controller 208. The key input unit 206 may further comprise a keypad, jog shuttle, point stick, touch screen or similar functioning devices.

The controller 208 controls the entire operation of the terminal. Specifically, the controller 208 is adapted to adjust the call volume of the terminal according to the determined result of the pressurization sensing unit 204.

For example, upon receiving a pressurization-sensing signal and pressure-level signal from the pressurization sensing unit 204, the controller 208 increases the call volume correspondingly to the level of pressure applied to the pressure part.

At this time, the controller 208 can increase the call volume by outputting a control signal instructing the call volume increase to the audio converter 214. On the other hand, when the pressurization sensing unit 204 senses that the pressure part is not pressurized after the call volume is increased, the controller 208 can return the call volume to its prior state before the volume was increased.

Alternatively, upon receiving the pressurization sensing signal and pressure level signal from the pressurization sensing unit 204, the controller 208 may increase the call volume of a microphone (not shown), for example by increasing the volume of an audio signal inputted through the microphone.

The display unit 210 displays a variety of information including the current state of the terminal. To this end, the display unit 210 may include a liquid crystal display (LCD). The information may include a power state, received signal strength, date and time, current mode state, and other user information.

The RF circuit 212 transmits and receives various data and signals to/from a base station through a wireless network. That is, the RF circuit 212 receives data and signals from an external mobile communication terminal or base station through an antenna, or transmits data and signals generated by the present mobile communication terminal through the antenna.

The audio converter 214 converts a received digital audio signal into an analog audio signal and outputs the converted analog audio signal to the speaker 216, or converts an analog audio signal to be transmitted into a digital audio signal and outputs the converted digital audio signal to the RF circuit 212.

The speaker 216 outputs the analog audio signal from the audio converter 214. Specifically, the speaker 216 outputs the audio signal with a call volume adjusted by the controller 208. The adjusted call volume corresponds to the applied pressure level according to the determination result of the pressurization sensing unit 204.

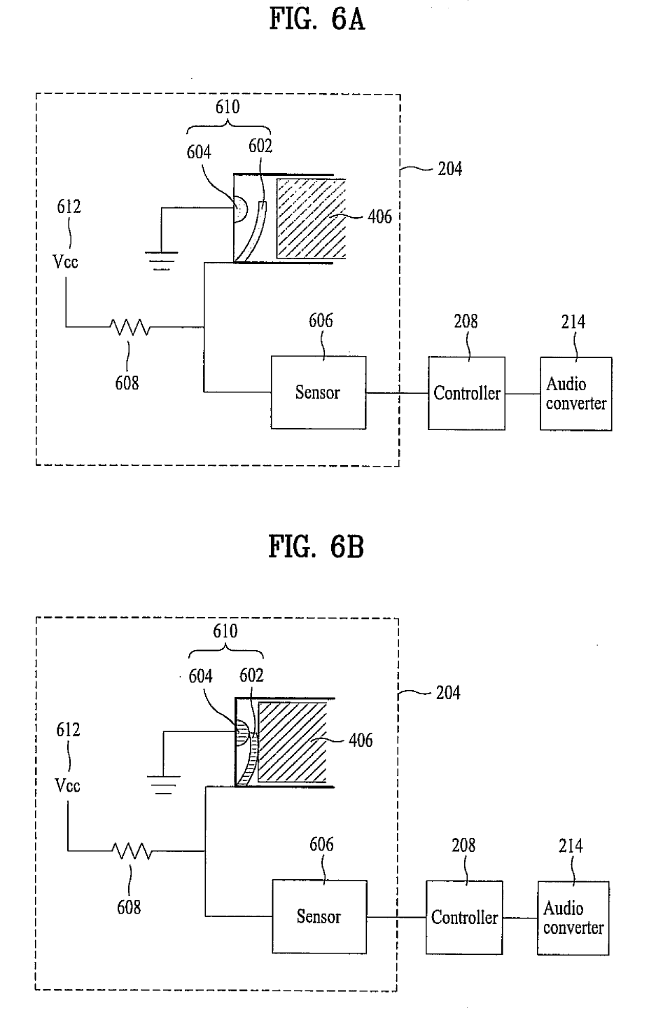

The internal configuration of a first embodiment of the pressurization sensing unit 204 according to the present invention will hereinafter be described in detail with reference to FIG. 6A and FIG. 6B.

As illustrated in FIG. 6A and FIG. 6B, the pressurization sensing unit 204 includes a switch 610 adapted to perform a switching operation in response to the applied pressure, a resistor 608 connected to a supply voltage terminal 612, and a sensor 606 adapted to determine the state of the switch 610 and the level of pressure applied to the pressure part. It will hereinafter be assumed that the pressure part to be pressurized is the stopper 406 (illustrated in FIGS. 4A and 4B). It will also be understood that the pressure part may be configured at a portion of the speaker (as illustrated in FIGS. 5A-5C).

The switch 610 includes a metal bar 602 and a metal dome 604. As the stopper 406 is pressed by pressure equal to or greater than the predetermined reference pressure level, the metal bar 602 and the metal dome 604 are brought into contact with each other and thus activate the switch 610. When pressure less than the reference pressure level or if no pressure is applied to the stopper 406, the metal bar 602 and the metal dome 604 are separated from each other and thus do not activate the switch 610. It should be noted that the switch 610 is not limited to the term “switch”, but refers to all devices that perform the switching operation in response to pressure applied thereto.

The resistor 608 includes at least one of a pull-up resistor and pull-down resistor, which is connected to the switch 610. The pull-up resistor is a resistor that is connected between a signal input terminal or output terminal and the supply voltage terminal to assume a high logic level in a digital circuit, and the pull-down resistor is a resistor that is connected between the signal input terminal or output terminal and a ground voltage terminal to assume a low logic level in the digital circuit in contrast to the pull-up resistor. For the convenience of description, the pull-up resistor will hereinafter be taken as an example.

FIG. 6A shows the non-contact state of the metal bar 602 and metal dome 604 when pressure equal to or greater than the reference pressure level is not applied to the stopper 406. When the metal bar 602 and the metal dome 604 are not brought into contact with each other, the switch 610 is turned off, thereby causing the sensor 606 to receive a signal of the high logic level. The high logic level means that all current from the supply voltage terminal 612 flows to the sensor 606. As a result, the sensor 606 recognizes that the stopper 406 is not pressurized. Then, the controller 208 determines from an output signal from the sensor 606 that the stopper 406 is not pressurized, and thus does not adjust the call volume.

FIG. 6B shows the contact state of the metal bar 602 and metal dome 604 when pressure equal to or greater than the reference pressure level is applied to the stopper 406.

When the metal bar 602 and the metal dome 604 are brought into contact with each other, the switch 610 is turned on, so that the sensor 606 receives a signal of the low logic level. This low logic level means that all current from the supply voltage terminal 612 flows externally through the switch 610, thereby causing no current to flow to the sensor 606. As a result, the sensor 606 senses that the stopper 406 is pressurized.

The sensor 606 may also determine the level of pressure applied to the switch 610 by the stopper 406. The pressurization sensing unit 204 may include a pressure sensor for sensing whether the stopper 406 is pressurized, the level of pressure applied to the stopper 406 and outputting the sensing results to the controller 208.

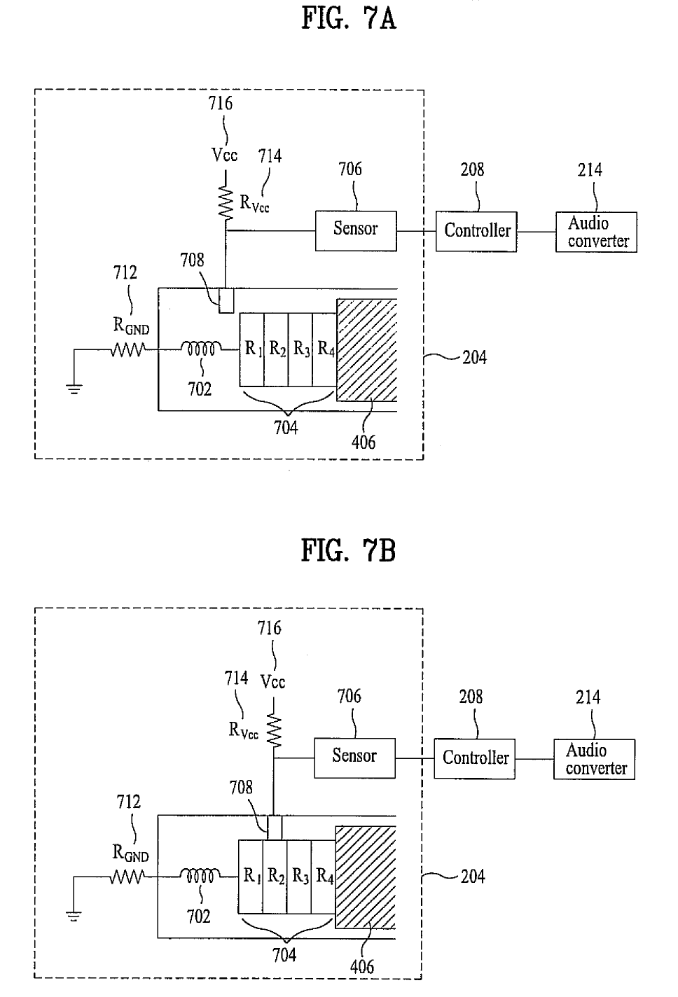

The internal configuration of a second embodiment of the pressurization sensing unit 204, in accordance with to the present invention will hereinafter be described in detail with reference to FIG. 7A and FIG. 7B.

As shown in FIG. 7A and FIG. 7B, the pressurization sensing unit 204 includes a variable resistor 704 having a resistance that varies with the pressing level of the stopper 406 based on the level of pressure applied to the stopper 406, a spring 702 connected between a ground resistor 712 and the variable resistor 704, a connector 708 for connecting a supply resistor 714 with the variable resistor 704, and a sensor 706 for sensing if the stopper 406 is pressurized and to determine the level of pressure applied to the stopper 406.

The spring 702 is elastically operated with pressure applied to the stopper 406. It should be noted here that the spring 702 is not limited to the term “spring”, but includes all members that are elastically operated with pressure.

The variable resistor 704 includes a first resistor R1, second resistor R2, third resistor R3, and fourth resistor R4. Thus, the variable resistor 704 has at least one of a resistance of R1, a resistance of R1+R2, a resistance of R1+R2+R3 and a resistance of R1+R2+R3+R4 depending on the pressure level of the stopper 406.

For example, as the pressure level of the stopper 406 becomes higher, the variable resistor 704 has resistances sequentially increasing in the order of R1, R1+R2, R1+R2+R3 and R1+R2+R3+R4.

When the variable resistor 704 is pressed by pressure applied to the stopper 406, the connector 708 is brought into contact with a portion of the variable resistor 704, for example, at least one of the resistors R1, R2, R3 and R4, so as to connect the variable resistor 704 with the supply resistor 714. As a result, the ground resistor 712, variable resistor 704 and supply resistor 714 are connected in series.

The sensor 706 senses that stopper 406 is pressurized when resistor R1 of the variable resistor 704 is connected to the connector 708.

Also, at the time that at least one of the resistors R1, R2, R3 and R4 of the variable resistor 704 is connected to the connector 708, the sensor 706 determines the level of pressure applied to the stopper 406 by measuring a voltage between the supply resistor 714 and the variable resistor 704, as will be described later in detail with reference to FIG. 7B.

FIG. 7A illustrates the non-connection state of the variable resistor 704 and connector 708 in the pressurization sensing unit 204 when pressure equal to or greater than the reference pressure level is not applied to the stopper 406.

Because the variable resistor 704 is not connected to the connector 708, the sensor 706 recognizes that the stopper 406 is not pressurized. As a result, the controller 208 determines from an output signal from the sensor 706 that the stopper 406 is not pressurized, and thus does not adjust the call volume.

FIG. 7B illustrates the connection state of the variable resistor 704 and connector 708 in the pressurization sensing unit 204 when pressure equal to or greater than the reference pressure level is applied to the stopper 406.

At the same time that the connector 708 is connected to the resistor R1 of the variable resistor 704, the sensor 706 senses that the stopper 406 is pressurized, and then enters a state for determining the level of pressure applied to the stopper 406.

A detailed description will hereinafter be given of a process of determining the level of the applied pressure by the sensor 706.

For the convenience of description, assume that each of the ground resistor 712, supply resistor 714 and resistors R1, R2, R3 and R4 have a resistance of 1Ω and the supply voltage terminal 716 has a voltage of 1 V.

When the connector 704 and the variable resistor 704 are connected with each other, the ground resistor 712, variable resistor 704 and supply resistor 714 are connected in series and the sensor 706 measures a voltage between the supply resistor 714 and the variable resistor 704.

For example, when the connector 708 is connected to the resistor R1, the ground resistor 712, resistor R1 and supply resistor 714 are connected in series and the sensor 706 measures a voltage of ⅔V, on the basis of the voltage division rule.

When the connector 708 is connected to the resistor R2, the ground resistor 712, resistor R1, resistor R2 and supply resistor 714 are connected in series and the sensor 706 measures a voltage of ¾V.

When the connector 708 is connected to the resistor R3, the ground resistor 712, resistor R1, resistor R2, resistor R3 and supply resistor 714 are connected in series and the sensor 706 measures a voltage of ⅘V.

When the connector 708 is connected to the resistor R4, the ground resistor 712, resistor R1, resistor R2, resistor R3, resistor R4 and supply resistor 714 are connected in series and the sensor 706 measures a voltage of ⅚V.

As stated above, as the level of the applied pressure increases, the connector 708 is sequentially connected to the variable resistor 704 in the order of the resistors R1, R2, R3 and R4. In this case, the sensor 706 measures the gradually increasing voltages in the order of ⅔V, ¾V, ⅘V and ⅚V.

Therefore, the sensor 706 can determine the level of the applied pressure on the basis of the measured voltage. Then, the sensor 706 converts the pressure level based on the measured voltage into a digital signal and outputs the converted digital signal to the controller 208.

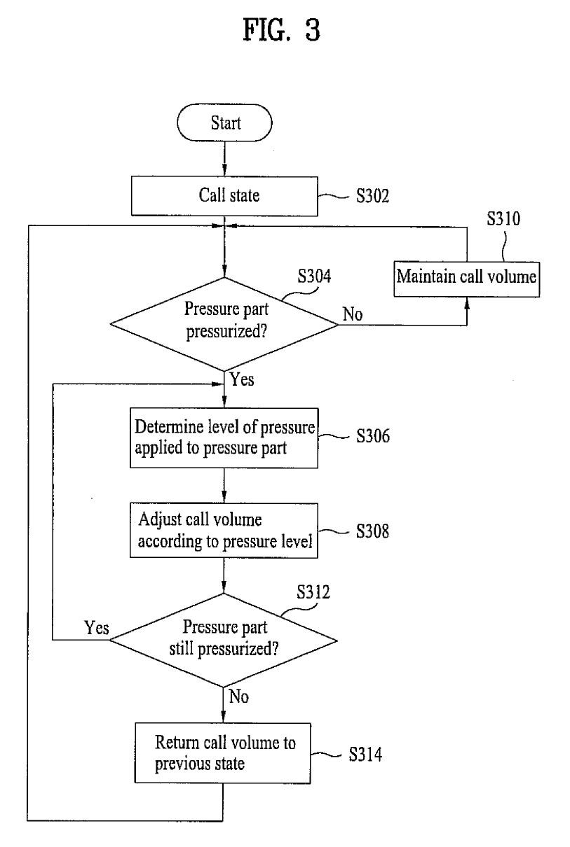

A method for adjusting the call volume of the mobile communication terminal according to the present invention will hereinafter be described in detail with reference to FIG. 3.

First, when the terminal is in a call state (S302), the pressurization sensing unit 204 determines if a pressure part of the terminal is pressurized (S304). For example, where the terminal is of a folder type, the pressure part may be a stopper provided between an upper folder and a lower folder. Alternatively, the pressure part may be provided at a portion of the speaker of the terminal. That is, the pressure part is a part of the terminal that can be sensitively pressurized as the user presses his ear against the terminal.

For example, the pressurization sensing unit 204 may determine if the pressure part is pressurized, using a switch adapted to perform a switching operation in response to pressure applied thereto, as stated previously with reference to FIG. 6A and FIG. 6B.

Alternatively, the pressurization sensing unit 204 may determine if the pressure part is pressurized, using a variable resistor whose resistance varies with pressure, as stated previously with reference to FIG. 7A and FIG. 7B.

Upon determining that the pressure part is pressurized, the pressurization sensing unit 204 determines the level of pressure applied to the pressure part (S306). For example, the pressurization sensing unit 204 may include a pressure sensor for determining if the pressure part is pressurized and the level of pressure applied to the pressure part.

Alternatively, the pressurization sensing unit 204 may determine if the level of pressure applied to the pressure part using a variable resistor whose resistance varies with pressure, as stated previously with reference to FIG. 7A and FIG. 7B.

The controller 208 adjusts the call volume according to the determined pressure level (S308). For example, the controller 208 may have predetermined call volume values corresponding respectively to various pressure levels. As a result, the controller 208 receives the determined pressure level from the pressurization sensing unit 204 and adjusts the call volume corresponding to the received pressure level.

For example, assume that the controller 208 receives pressure levels divided into five steps from the pressurization sensing unit 204. The higher pressure step refers to the higher pressure level. Also, assume that a call volume before being adjusted due to pressurization is a call volume of step 1. Upon receiving a pressure level of step 1, the controller 208 adjusts the current call volume to a call volume of step 2 by increasing it by one step.

Upon receiving a pressure level of step 2, the controller 208 adjusts the current call volume to a call volume of step 3 by increasing it by two steps.

Upon receiving a pressure level of step 3, the controller 208 adjusts the current call volume to a call volume of step 4 by increasing it by three steps.

Here, the value of the call volume corresponding to one volume step may correspond to pushing the volume key of the terminal, or may be arbitrarily specified and stored by the user.

On the other hand, if it is determined that the pressure part is not pressurized, the controller 208 maintains the current call volume as it is (S310). Then, the pressurization sensing unit 204 determines if the pressure part is still pressurized (S312).

If it is determined that the pressure part is no longer pressurized after the call volume has been increased, the controller 208 returns the call volume to its previous state before the volume was increased (S314). For example, when the call volume before being increased is 2 dB and the call volume increased due to pressurization is 3 dB, the controller 208 returns the call volume to 2 dB if it is determined that the pressure part is no longer pressurized.

If it is determined that the pressure part is still pressurized after the call volume has been increased, the controller 208 returns to step S306 to determine if the level of pressure has increased, decreased or remained the same to thereby either maintain the present increased volume level or increase or decrease the volume level according to an increased or decreased pressure. For example, when the call volume has been increased to 3 dB due to a first increase in pressurization and the pressure part is still pressurized, the controller 208 increases the call volume to 4 dB if it is determined that the pressure part is pressurized further and maintains the call volume at 3 dB if it is determined that the level of pressure is the same. Further, if the call volume is increased to 4 dB due to a second detected increase in pressure and the pressure part is still pressurized, the controller 208 increases the call volume to 5 dB if it is determined that the pressure part is pressurized further, decreases the call volume to 3 dB if it is determined that the pressure part is pressurized less and maintains the call volume at 4 dB if it is determined that the level of pressure is the same.

In accordance with the present invention, a determination can be made as to whether a pressure part of a mobile communication terminal is pressurized and the level of pressure applied to the pressure part, according to a degree that the pressure part is pressurized, and the call volume of the mobile communication terminal can be adjusted according to the determination result. Therefore, it is possible to adjust the call volume simply and conveniently without operating a separate key.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for adjusting a call volume of a mobile communication terminal, the method comprising:
sensing whether a pressure part of the mobile communication terminal is pressurized;
determining a level of pressure applied to the pressure part upon sensing that the pressure part is pressurized; and
adjusting the call volume of the mobile communication terminal according to the determined pressure level.

2. The method of claim 1, wherein the mobile communication terminal is a folder type and the sensing step comprises sensing whether a stopper attached between an upper folder and a lower folder is pressurized.

3. The method of claim 1, wherein the sensing step comprises sensing whether a portion of a speaker of the mobile communication terminal is pressurized.

4. The method of claim 1, wherein the sensing step comprises sensing whether a switch adapted to perform a switching operation is closed in response to the applied pressure.

5. The method of claim 4, wherein the determining step comprises using a pressure sensor to determine the pressure level applied to the pressure part.

6. The method of claim 1, wherein the determining step comprises using a variable resistor having a resistance that varies with the pressure level to determine the level of the pressure applied to the pressure part.

7. The method of claim 1, wherein the adjusting step comprises returning the call volume to a previous state, if it is sensed that the pressure part is no longer pressurized after the call volume has been increased.

8. A mobile communication terminal with a call volume adjustment function, the mobile communication terminal comprising:
a pressurization sensing unit adapted to sense whether a pressure part of the mobile communication terminal is pressurized, and to determine a level of pressure applied to the pressure part;
a controller adapted to adjust a call volume of the mobile communication terminal according to a result of the pressurization sensing unit; and
a speaker adapted to output an audio signal with the adjusted call volume.

9. The mobile communication terminal of claim 8, wherein the pressure part comprises a stopper provided between an upper folder and a lower folder when the mobile communication terminal is a folder type.

10. The mobile communication terminal of claim 81 wherein the pressure part is provided at a portion of the speaker.

11. The mobile communication terminal of claim 8, wherein the pressurization sensing unit comprises a pressure sensor.

12. The mobile communication terminal of claim 8, wherein the pressurization sensing unit comprises:
a switch adapted to perform a switching operation in response to pressure applied thereto; and
a sensor adapted to determine a state of the switch and the level of the pressure applied to the pressure part.

13. The mobile communication terminal of claim 12, wherein the switch is connected to at least one of a pull-up resistor and a pull-down resistor.

14. The mobile communication terminal of claim 8, wherein the pressurization sensing unit comprises:
a variable resistor having a resistance that varies with pressure; and
a sensor adapted to determine the level of the pressure applied to the pressure part according to the varying resistance of the variable resistor.

15. The mobile communication terminal of claim 8, wherein the controller returns the call volume to a previous state before, if it is sensed that the pressure part is no longer pressurized after the call volume has been increased.

16. A method for adjusting a call volume of a mobile communication terminal, the method comprising:
sensing whether a pressure part of the mobile communication terminal is pressurized;
determining a level of pressure applied to the pressure part upon sensing that the pressure part is pressurized; and
adjusting the call volume of the mobile communication terminal according to the determined pressure level,
wherein the level of pressure is determined by the pressure of a user's ear on the pressure part.

17. The method of claim 16, wherein the sensing step comprises sensing whether a portion of a speaker of the mobile communication terminal is pressurized.

18. The method of claim 16, wherein the sensing step comprises using a switch adapted to perform a switching operation in response to the applied pressure.

19. The method of claim 16, wherein the determining step comprises using a variable resistor having a resistance that varies with the pressure level to determine the level of pressure applied to the pressure part.

20. A mobile communication terminal with a call volume adjustment function, the mobile communication terminal comprising:
a pressurization sensing unit adapted to sense whether a pressure part of the mobile communication terminal is pressurized, and to determine a level of pressure applied to the pressure part;
a controller adapted to adjust a call volume of the mobile communication terminal according to a result of the pressurization sensing unit; and
a speaker adapted to output an audio signal with the adjusted call volume,
wherein the pressure part is provided at a portion of the speaker, and the level of pressure is determined according to the pressure of a user's ear on the pressure part.
